(19) United States
(12) Patent Application Publication
(10) Pub. No.: US 2009/0178477 A1
(43) Pub. Date: Jul. 16, 2009

(54) DIFFERENTIAL PRESSURE SENSOR ASSEMBLY AND METHOD

(75) Inventor: Gary L. Casey, Thousand Oaks, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: CUSTOM SENSORS & TECHNOLOGIES, INC., Moorpark, CA (US)

(21) Appl. No.: 12/014,040

(22) Filed: Jan. 14, 2008

(51) Int. Cl. G01F 7/00

(52) U.S. Cl. 73/196

(57) ABSTRACT

The pressure at a pressure sensor is cycled between a higher (upstream) pressure and a lower (downstream) pressure. The pressure sensor senses the higher and lower pressures, and the difference therebetween is calculated and output. The pressure sensor can be a “single-pressure” pressure sensor (gage or absolute) where the pressure sensor is alternately connected between the two pressures.

### BACKGROUND OF THE INVENTION

Differential pressure sensors are used in heating, ventilating and air conditioning (HVAC) systems. An example thereof is illustrated in FIG. 1 generally at 50, which shows a duct 54 having a damper 58 therein, and with “clean” air 62 flowing therethrough. In order to determine the position of the damper 58, a pressure tap 66 upstream of the damper and a pressure tap 70 downstream of the damper are provided. These pressure taps are connected to a differential pressure (DP) sensor 74. Even with the damper 58 closed, the differential pressure is very small, for example, one inch of water, a very small portion of the atmospheric pressure in the duct 54. That is, very small differential pressures, on the order of one to five inches water full scale, are measured in this application.

### SUMMARY OF THE INVENTION

Disclosed herein are improved differential pressure sensor assemblies and methods.

According to one preferred embodiment, the media is valved to an absolute or gage (“single-pressure”) sensor such that the output of the sensor alternates between the high pressure and low pressure ports. Since the pressure cavity of the sensor can be made very small, only a small amount of air has to be switched. Therefore, the “leakage” can be made to be very low, within commercially acceptable limits. One way to do this uses a fluidic oscillator. Another way uses a “micro-valve” constructed of silicon, for example, and which is controlled by sensor electronics. In either case, the changes of sensor output can be amplified and calibrated.

According to another preferred embodiment of the invention, a sensor is alternately exposed to the upstream pressure and the downstream pressure, which produces an output that changes from one level to another. This output can be measured by a conventional electronic circuit that amplifies the change in pressure instead of the total voltage as is typically done.

According to a further preferred embodiment of the invention, a differential pressure sensor assembly includes a pressure sensor and cycling means for causing a pressure at the pressure sensor to cycle between an upstream pressure and a downstream pressure such that the pressure sensor can measure a difference between the upstream and downstream pressures. The cycling means can use the Coanda effect, can include a pressure-actuated valve, and/or can include a solenoid valve.

According to another preferred embodiment of the invention, a differential pressure sensing assembly includes means for cycling or oscillating a pressure at a “single-pressure” pressure sensor between an upstream pressure and a downstream pressure such that the pressure sensor measures the difference between the upstream and downstream pressures.

According to a further preferred embodiment of the invention, a method for measuring the difference between an upstream pressure and a downstream pressure, includes cycling the pressure at a pressure sensor between the upstream pressure and the downstream pressure and the pressure sensor measuring the difference between the detected upstream downstream pressures thereat.

According to a still further preferred embodiment of the invention, a pressure differential sensing assembly includes: a solenoid assembly including an armature; a first fluid passage having a first port adapted to be in fluid communication with the solenoid assembly; a second fluid passage having a second port adapted to be in fluid communication with the solenoid assembly; a pressure sensor in fluid communication with the solenoid assembly between the first and second passages; the armature being movable back and forth between a first condition wherein pressure at the pressure sensor is at a pressure of the first fluid passage and a second condition wherein pressure at the pressure sensor is at a pressure of the second fluid passage; and the pressure sensor being capable of measuring the difference between the detected pressures of the first and second passages.

According to yet a still further preferred embodiment, pressure differential sensing assembly, including: a solenoid assembly communicable with a first fluid passage and with a second fluid passage downstream of the first fluid passage; the solenoid assembly including an armature; a pressure sensor; the armature being movable with a back-and-forth movement between a first condition wherein pressure at the pressure sensor is at a pressure of the first fluid passage and a second condition wherein pressure at the pressure sensor is at a pressure of the second fluid passage, and the back-and-forth movement allowing the pressure sensor to measure a difference between the pressures of the first fluid passage and the second fluid passage.

The sensing assembly disclosed above wherein the solenoid assembly is a double-acting solenoid assembly, the armature when in the first condition is in a de-energized condition, biased against a port between the first fluid passage and the solenoid assembly, and the armature when in the second condition is in an energized condition against a port between the second fluid passage and the solenoid assembly.

The sensing assembly disclosed above wherein the solenoid assembly is a single-acting solenoid assembly, the armature when in the second condition is in a de-energized condition and is in a port-closed position of a port between the first passage and the solenoid assembly and when in the first condition is in an energized condition and is in a port-open position of the port.

The sensing assembly disclosed above wherein a connecting passage extends between the solenoid assembly and the pressure sensor, the second passage connects to the connecting passage between the solenoid assembly and the pressure sensor, and an orifice is positioned between the connecting passage and the second passage.

Yet further disclosed herein is a pressure differential sensing method, comprising: cycling a solenoid assembly, which is communicable with a first fluid passage and a second fluid passage, between an energized condition wherein pressure detected at a pressure sensor is a pressure of the first fluid passage and a de-energized condition wherein pressure detected at the pressure sensor is a pressure of the second fluid passage, one of the first and second fluid passages being an upstream pressure with respect to the other.

The method disclosed above wherein the cycling causes the pressure sensor to output a pressure difference of the pressures of the first fluid passage and of the second fluid passage detected by the pressure sensor.

The method disclosed above wherein the first fluid passage connects to the solenoid assembly at a first port of the solenoid assembly, the second fluid passage connects to the solenoid assembly at a second port of the solenoid assembly, and the solenoid assembly is a double-acting solenoid assembly.

The method disclosed above wherein the first fluid passage connects to the solenoid assembly at a first port of the solenoid assembly, a connector passage connects the solenoid assembly to the pressure sensor, the second fluid passage connects to the connector passage between the solenoid assembly and the pressure sensor, an orifice is positioned between the connector passage and the second fluid passage, and the solenoid assembly is a single-acting solenoid assembly.

Other objects and advantages of the present invention will become more apparent to those persons having ordinary skill in the art to which the present invention pertains from the foregoing description taken in conjunction with the accompanying drawing.

### BRIEF DESCRIPTION OF THE DRAWINGS

FIG. 1 is an elevational view of a differential pressure sensor system of the prior art and a configuration which can be adapted to use the present invention;

FIG. 2 is an elevational view of a differential pressure sensor assembly of the present invention illustrating fluid flow therein at a first time in its cycle;

FIG. 3 is an elevational view of the assembly of FIG. 2 illustrating fluid flow therein at a second time in its cycle;

FIG. 4 is an elevational view of the assembly of FIG. 2 illustrating fluid flow therein at a third time in its cycle;

FIG. 5 is a first pressure-time graph of the assembly of FIG. 2;

FIG. 6 is a second pressure-time graph of the assembly of FIG. 3;

FIG. 7 is a third pressure-time graph of the assembly of FIG. 4;

FIG. 8 is a fourth pressure-time graph of the assembly of FIGS. 2-4;

FIG. 9 is an elevational view of a second differential pressure sensor assembly of the present invention; and

FIG. 10 is an elevational view of a third differential pressure sensor assembly of the present invention.

### DETAILED DESCRIPTION OF THE INVENTION

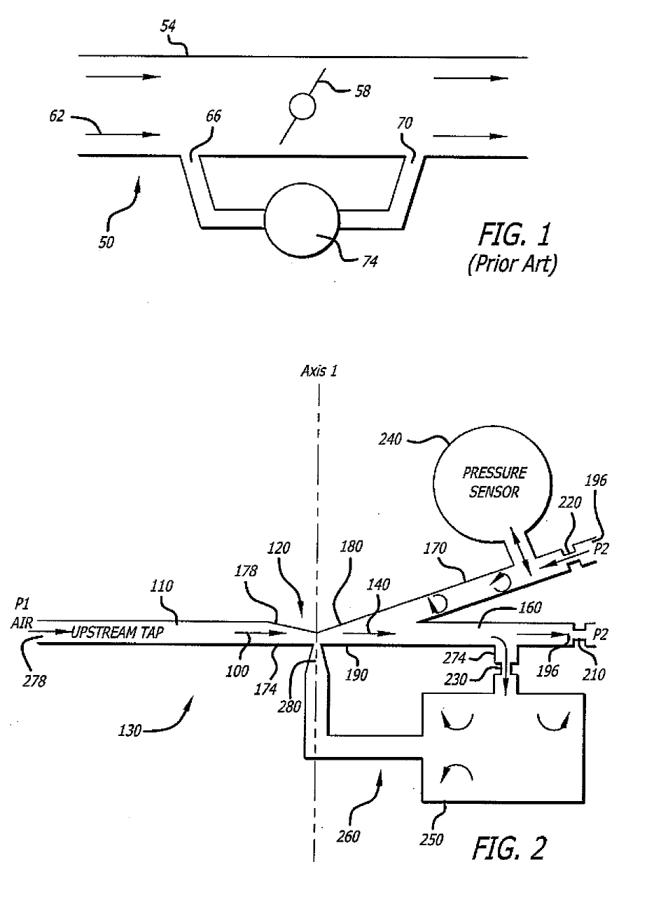

Referring to the drawings wherein like reference numerals designate like parts, disclosed herein are sensor assemblies that can measure the difference in pressure between an upstream or higher pressure source P1 and a downstream or lower pressure source P2. While a likely application of this invention is in the HVAC industry, such as illustrated in FIG. 1, where only a small differential pressure is to be measured, there are numerous other similar applications as would be apparent to those skilled in the art.

Referring to FIGS. 2-4, clean air or other fluid 100, passes from pressure source P1 through a passage 110 to a nozzle 120 of this assembly shown generally at 130. The nozzle 120 accelerates the flow of the air. The accelerated air 140 flows from the nozzle 120 into the junction of a first passage 160 and a second passage 170. The second passage 170 is at an angle of generally between ten degrees and twenty or twenty-two degrees relative to the first passage 160, the angle lying in a vertical plane. (The first and second passages 160, 170 can rejoin downstream.)

While a number of configurations are possible, one configuration assumes that the passages 160, 170 are rectangular in section and thus surfaces 174 and 178 can be considered to be flat. At the nozzle 120 the upper surface 180 and the lower surface 190 begin to diverge. While the lower surface 190 remains essentially planar with surface 174, the upper surface 180 creates an angle with the surface 178.

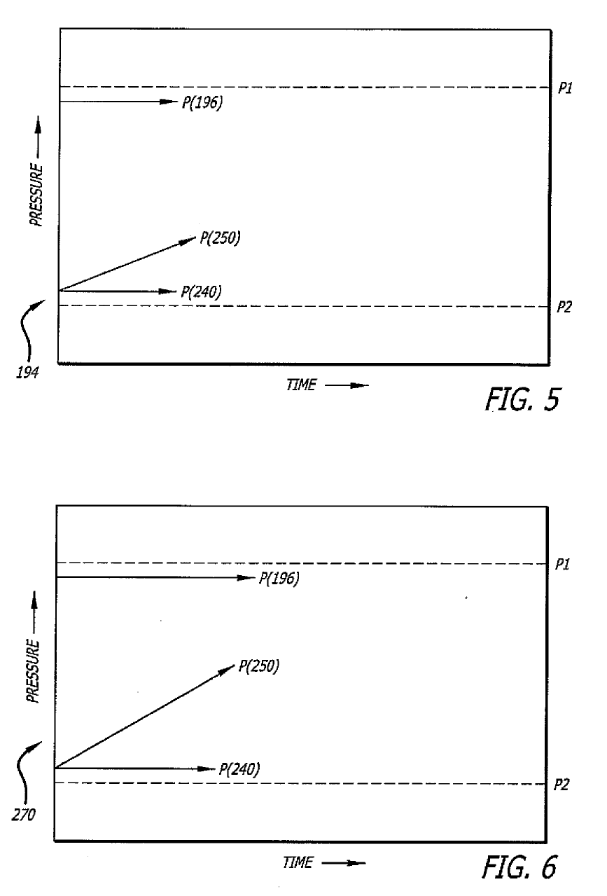

An initial condition of assembly 130 is illustrated in FIG. 2 and the graph 194 of FIG. 5. In the absence of any disturbance, the air flow that has been accelerated through the nozzle 120 will tend to separate from the upper surface 180 and “cling” to the lower surface 190 due to the “Coanda effect,” which is also known as “boundary layer attachment.” The Coanda effect can be defined as “the tendency of a stream of fluid to stay attached to a convex surface, rather than follow a straight line in its original direction.” Another definition is the phenomena in which a jet flow attaches itself to a nearby surface and remains attached even when the surface curves away from the initial jet direction. It further is mentioned in Henri Coanda's U.S. Pat. No. 2,108,652, whose entire contents are hereby incorporated by reference.

Because the flow in passage 196 is constricted by orifice 210 the pressure will build up in this area to a pressure nearly equal to the upstream pressure P1. The first passage 160 and the second passage 170 are both connected to the downstream pressure P2 through respective orifices 210 and 220. Since there is no flow in the second passage 170, the pressure will remain essentially equal to the downstream pressure P2 at 196; and, in fact, flow can be in the reverse direction from P2 into passage 170 as shown. The pressure P(s) in the pressure sensor 240 will essentially be equal to P2.

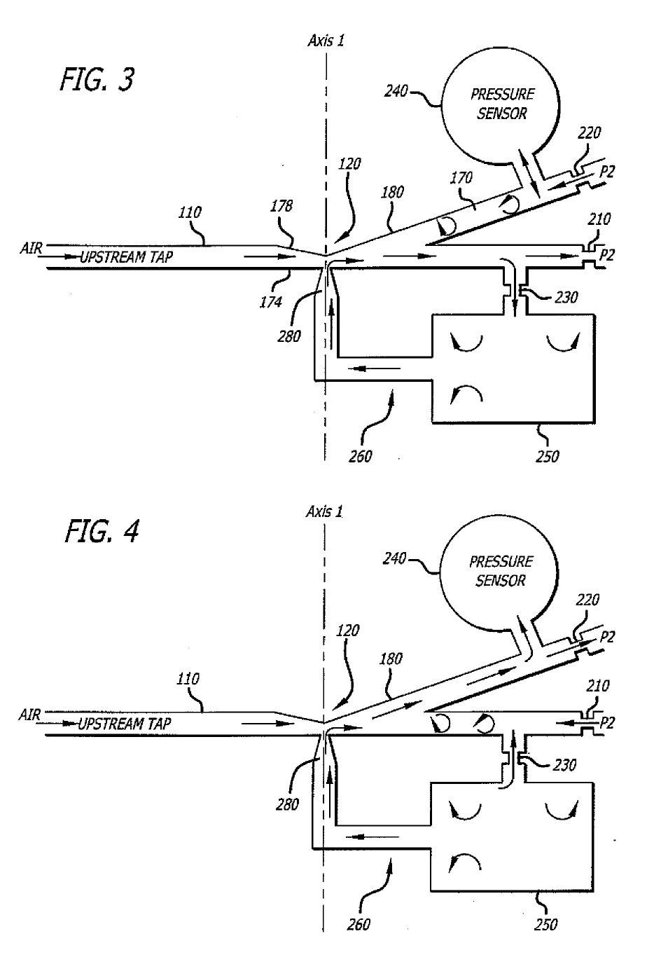

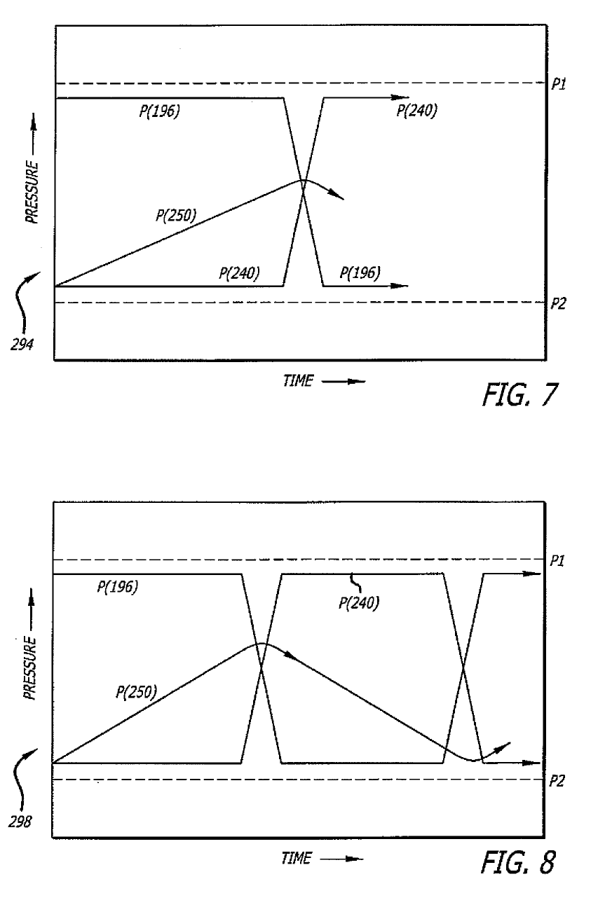

The high pressure in the first passage 160 will cause a flow into the reservoir 250 through the loop passage 260, restricted by the orifice 230. Reference is now made to FIG. 3 and the graph 270 of FIG. 7. The pressure in the reservoir 250 will increase because of the flow into the passage 274, but only gradually due to the relatively large size of the reservoir. Flow from the reservoir 250 through the passage 260 to the diverter nozzle 280 starts and gradually increases in velocity. Because of the high velocity, the local pressure in the nozzle 120 is low, significantly lower than the upstream pressure at 278.

When the pressure in the reservoir 250 increases sufficiently to cause flow through the diverter nozzle 280 to also increase, a point is reached when the flow rate through the diverter nozzle 280 is sufficient to “trip” the main air flow through the nozzle 120 and prevent flow attachment to the lower surface 190. Given the choice the air will not split and attach to both surfaces, but rather, will attach to the “easiest” surface, which in this case is the upper surface 180. The lower surface 190 does not have to exactly collinear with the upstream surface 174, just angled down a small amount such that the air will follow that surface unless disturbed. The Coanda effect pulls the boundary layer air into the main part of the air stream and thus creates a vacuum at the surface sufficient to hold high-velocity jet close (attached) to the surface.

If enough air, preferably at an angle to the surface and at a relatively high velocity, is directed through openings in the surface at the air jet, it will overcome the ability of the air jet to maintain the required vacuum at the surface, in essence “losing its grip” on the surface. In that case, the air jet will then be attracted to any available surface, which in this case is the upper surface 180. Once it attaches to that surface, it will tend to remain attached until the “tripping” jet gets to a much lower velocity. In other words, there is a built-in hysteresis in this design, making the flow bi-stable. If the angle of the upper surface 180 is too small, the jet may never return, so that creates the lower limit on the angle. The optimum angle depends on a number of variables such as the radius of the intersection, and the pressure, velocity, density and viscosity of the fluid. If the angle is too small, the passage will act like the diffuser section of a venturi and the air will attach to both surfaces with the velocity reducing as it goes downstream, preventing the system from working. The pressure range for a pressure sensor 240 will typically be from zero up to the maximum operating pressure. Since the system likely cannot be made to work down to exactly zero, the configuration should be optimized to provide the maximum range possible.

At that point, and referring to FIG. 4 and the graph 294 of FIG. 7, the flow will become attached to the upper surface 180, thereby directing the flow from the nozzle 120 into the second passage 170. Because of the restriction provided by the orifice 290, the pressure in the second passage 170 will rise to nearly that of P1. The pressure in the first passage 160 will immediately drop to essentially that of the downstream pressure P2. This allows the flow to reverse in the orifice 210 and is necessary to equilibrate the pressure between P2 and the first passage 160. The pressure in the reservoir 250 will start to drop due to the combined flow out of the reservoir through both orifice 230 and the nozzle 280. Eventually the pressure will reach a pressure which is sufficiently low such that the velocity of air through the nozzle 280 will be insufficient to prevent the air coming into the nozzle 120 from re-attaching to the lower surface 190. As can be understood from the graph 298 of FIG. 8, flow is now directed into the first passage 160 and the process repeats itself.

The larger the reservoir 250, the lower the frequency of the cycling of the flow between the first and second passages 160, 170. It is desirable that the pressure at the pressure sensor 240 reaches equilibrium at both the upper pressure and the lower pressure, which can take some time. Thus if the frequency is too high, the pressure will not get up or down to the final value, thereby reducing the accuracy of the measurement. If the reservoir 250 is too large, the time required for a measurement will be unnecessarily long. The optimum value can be easily derived experimentally.

The configuration of this sensor assembly 130 is effective because the nozzle 120 is “bi-stable,” as mentioned above, in that flow can be made stable in either of two modes, namely the first condition wherein flow is into the first passage 160 and the second condition wherein flow is into the second passage 170. The frequency of oscillation between these two conditions depends on a number of factors including the upstream pressure P1, the geometries of the flow passages and the size of the reservoir 250. Although typical frequencies can be between one and one hundred Hz, other frequencies can be equally effective. The pressure sensor 240 should have a response capability sufficient to accurately measure the dynamic pressure (which is the difference in pressure between P1 and P2). Examples of sensors 240 that can be used have response times between one and five msec, making it possible to measure frequencies up to at least one hundred Hz.

An example of a sensor 240 are sensors used to measure small differential pressures in air conditioning system ductwork, such as a conventional Barometric Absolute Pressure (BAP) sensor. The sensitivity (gain) of the sensor 240 should be stable and the resolution should be very good. This is generally the case of analog sensors of reasonable quality since the sense elements are frictionless and free from hysteresis. An example of a preferred commercially available sensor is the Kavilco HVAC DP sensor available from Kavlico Corporation of Moorpark, Calif.

In other words, the second (upper) passage 170 experiences a pressure that alternates between P1 and P2, and therefore the pressure sensor 240 which is on the second passage is exposed to this same pressure oscillation. The electrical output of the sensor 240 is detected by an electronic module (not shown) that determines the amplitude of the oscillation, which corresponds to the pressure difference between P1 and P2. As can be understood by those skilled in the art, this measurement depends on the oscillation amplitude and not the frequency of the oscillation.

The maximum amplitude possible is the differential pressure to be measured. In practice, the pressure sensor 240 will likely never reach the ideal pressure, either at the maximum or the minimum, so there will be some inherent error in the measurement. This can be within the accuracy requirements of the application or a compensation factor can be applied to the reading.

That is, the present system seeks out the maximum and minimum pressures detected in a given time frame. Generally, the present sensing method does not provide as fast a response to pressure changes as conventional sensors do. For example, a direct-measuring sensor would likely have a response time of one to twenty msec, while the present sensor assembly 130 would likely have a response time on the order of one hundred msec to one second. While the oscillation frequency is not important, a reasonable frequency would be on the order of between ten Hz and one hundred Hz. To provide a reasonably noise-free signal as many as ten cycles should be averaged, giving the previously-mentioned response time of one hundred to one thousand msec.

To utilize this system the output of the pressure sensor 240 is determined and the high and low values of pressure are determined electronically. Instead of having a sensing element that directly measures both pressures and thereby is very delicate and subject to damage, both pressures are advantageously determined by a single sensor 240. Thus, this sensor 240 is not required to have a high degree of absolute accuracy as it should only be free from hysteresis and have an accurate sensitivity (gain). The output of the sense element or sensor will not change when the differential pressure is zero since the amplitude of the oscillation will go to zero. Therefore, the zero output will be stable and accurate.

The invention is thus directed to the measurement of the difference of two pressures where there is allowed to be leakage between the two pressures and one (the “upstream” pressure P1) is always higher than the other (the “downstream” pressure P2). One of the pressures can be atmospheric, making it a “gage” pressure. A primary application of the invention can be the measurement of pressure differences too small for conventional low-cost sensors. For example, pressure sensors that can measure less than 0.1 bar are relatively more expensive. A one-bar sensor can usually be expected to have a “sensitivity” of considerably less than 0.001 bar. In other words, it can accurately detect a change of as little as 0.001 bar, although it will not be able to accurately measure the true value. In contrast, the present invention allows for the use of a higher-pressure (that is, lower cost) sensors 240 to measure very low pressures by exposing the sensor to one and then the other pressure, and then measuring the change in output, ignoring the absolute value.

An example of another pressure sensor 240 which can be used is a conventional silicon-based Piezo-Resistive (PRT) sensor and it is considerably more expensive below about five psi operating pressure. The present invention allows this sensor to be used in an application of generally 0.05 psi maximum pressure. With today's technology, a conventional sensor in that pressure range would be extremely expensive.

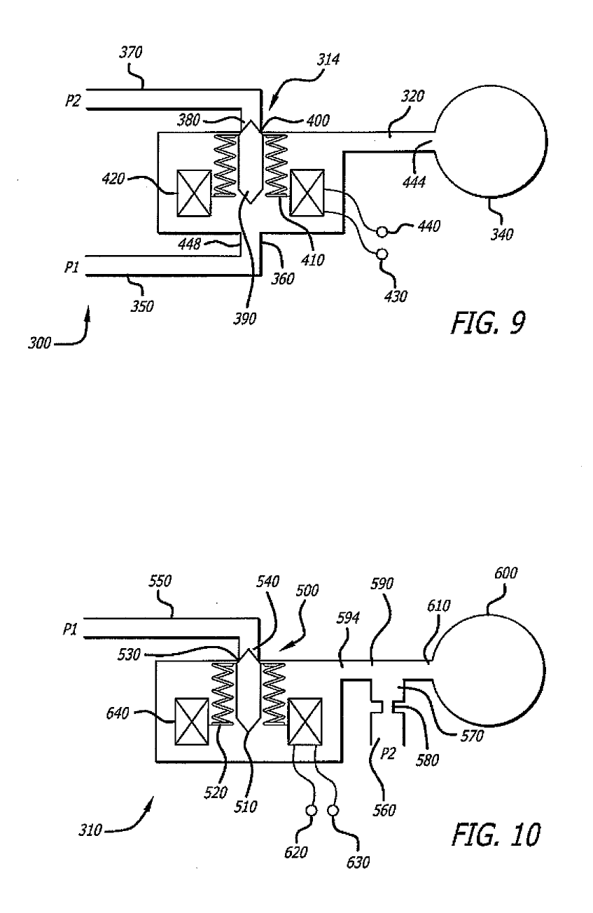

An alternative to the embodiment of the sensor assembly of FIGS. 2-4 are the solenoid-actuated sensor assemblies as shown generally at 300 and 310 in FIGS. 9 and 10, respectively. As will be understood from the detailed disclosures to follow and the drawings, the sensor assemblies 300, 310 function similar to the sensor assembly 130.

Referring to FIG. 9, the sensor assembly 300 includes a double-acting solenoid assembly illustrated generally at 314 and operatively connected via a connector passage 320 at port 330 to a pressure sensor 340. Passage 350, which communicates with P1, is connected to the solenoid assembly 314 at port 360. Similarly, passage 370, which communicates with P2, is connected to the solenoid assembly 314 at port 380. An armature 390 of the solenoid assembly 314 is biased against valve seat 400 at port 380 by a spring 410. The coil 420 of the solenoid assembly is energized by electric current applied to the terminals 430 and 440. In the de-energized position of the solenoid assembly 300 the port 380 is closed by the armature 390 and the pressure in port 444 and therefore at the pressure sensor 340 is equal to P1.

When the coil 420 is energized, the armature 390 is drawn downward (with reference to FIG. 9) against the bias of spring 410, until it rests against valve seat 448 at port 360. In this energized position, the pressure in port 444 and therefore at the pressure sensor 340 is equal to P2. Therefore, alternately energizing and de-energizing the coil 420, as by suitable electronics (not shown) connected to the terminals 430, 440, creates a pressure in the pressure sensor 340 that alternates between P1 and P2, similar to that shown in FIG. 8. The sensor output can be determined by the same method as discussed above.

Sensor assembly 310, which is illustrated in FIG. 10, includes a single-acting solenoid assembly shown generally at 500 in a de-energized condition, the armature 510 is biased by spring 520 against the valve seat 530. The valve seat 530 is at the port 540 for the passage 550 which is subject to pressure P1. Passage 560 which is subject to pressure P2 connects at port 570 via an orifice 580 to the connecting passage 590. One end of connecting passage 590 connects at port 594 to the solenoid assembly 500 and the opposite end connects to the pressure sensor 600. When the solenoid assembly 500 is in the de-energized condition as depicted in FIG. 10, the pressure in the connector passage 590 and therefore at the pressure sensor 600 is P2. This is because P2 exists in port 610, which connects to the pressure sensor 600 through the port 570 through orifice 580 and because there is no flow in the system.

When the solenoid assembly is in an energized condition by applying an electric current via terminals 620, 630 to the coil 640, the armature 510 is drawn downward as can be understood from FIG. 10. The armature 510 is unseated from the valve seat thereby opening the valve. If the flow capacity of the valve is large compared to the flow capacity of the orifice 580, the pressure in the sensor 600 will now be approximately equal to P1. Thereby, the sensor assembly 310 can be cycled between pressures P1 and P2 by periodically energizing the coil 640 of the solenoid assembly using a suitable control module.

From the foregoing detailed description, it will be evident that there are a number of changes, adaptations and modifications of the present invention which come within the province of those skilled in the art. Further, the scope of the invention includes any combination of the elements from the different species and embodiments and methods disclosed herein, as well as subassemblies, assemblies, and methods of using and making thereof, and combinations thereof. It is intended that all such variations not departing from the spirit of the invention be considered as within the scope thereof.

What is claimed is:

1. A pressure differential sensing assembly, comprising:
a single-pressure pressure sensor; and
means for cycling a pressure detectable by the pressure sensor between a higher pressure and a lower pressure.

2. The sensing assembly of claim 1 further comprising the cycling means including a first passage, a second passage angled with respect to the first passage at a junction therebetween, a nozzle downstream of the higher pressure and discharging into the junction, and a loop passage from the first passage to the nozzle; and the pressure sensor being in communication with the second passage.

3. The sensing assembly of claim 2 wherein when the cycling means is in a first flow condition fluid flows from the loop passage into the nozzle until that flow reaches a first pressure which causes flow out of the nozzle into the junction to switch from the first flow condition wherein flow from the junction is into the first passage to a second flow condition wherein flow from the junction is into the second passage and when flow from the loop passage into the nozzle drops to a second pressure flow out of the nozzle into the junction switches from the second flow condition back to the first flow condition.

4. The sensing assembly of claim 3 wherein the pressure sensor measures the higher pressure when the cycling means is in the second flow condition and measures the lower pressure when the cycling means is in the first flow condition.

5. The sensing assembly of claim 2 wherein the cycling means includes a reservoir in the loop passage, an orifice in the loop passage between the reservoir and the first passage, an orifice in the first passage and downstream of the loop passage, an orifice in the second passage and downstream of the pressure sensor, and a diverter nozzle from the loop passage into the nozzle.

6. The sensing assembly of claim 1 wherein the cycling means includes a solenoid assembly.

7. The sensing assembly of claim 6 wherein the solenoid assembly is a single-acting solenoid assembly having an armature which when in a de-energized condition causes the pressure at the pressure sensor to be the lower pressure.

8. The sensing assembly of claim 6 wherein the solenoid assembly is a double-acting solenoid assembly having an armature which when in a de-energized condition causes the pressure at the pressure sensor to be the downstream pressure.

9. The sensing assembly of claim 1 further comprising the cycling means including:
a solenoid assembly communicable with a first fluid passage and with a second fluid passage downstream of the first fluid passage;
the solenoid assembly including an armature;
the armature being movable with a back-and-forth movement between a first condition wherein pressure at the pressure sensor is at a pressure of the first fluid passage and a second condition wherein pressure at the pressure sensor is at a pressure of the second fluid passage, and
the back-and-forth movement allowing the pressure sensor to measure a difference between the pressures of the first fluid passage and the second fluid passage.

10. A pressure differential sensing assembly, comprising:
a first passage;
a second passage;
a nozzle in a passage and discharging into a junction between the first passage and the second passage, the second passage being upwardly angled relative to the second passage;
a loop passage from the first passage to the nozzle;
a pressure sensor operatively connected to the second passage downstream of the junction; and
flow from the loop passage into the nozzle causing flow from the nozzle to cycle between an upstream pressure upstream of the nozzle and a downstream pressure downstream of the nozzle at the pressure sensor, which measures the difference between the upstream and downstream pressures.

11. The sensing assembly of claim 10 wherein the loop passage includes a reservoir, a diverter nozzle into the nozzle and an orifice between the reservoir and the first passage, and the angle between the first and second passages is between generally 10 and 22 degrees.

12. A pressure differential measuring method, comprising:
cycling a pressure at a single-pressure pressure sensor between a first pressure and a lower second pressure, and the pressure sensor measuring a difference between the first pressure and the second pressure.

13. The method of claim 12 wherein the first pressure is an upstream pressure of a flow system which includes the pressure sensor and the second pressure is a downstream pressure of the flow system.

14. The method of claim 12 wherein the cycling uses the Coanda effect.

15. The method of claim 12 wherein the cycling uses a pressure-actuated valve.

16. The method of claim 12 wherein the cycling uses a solenoid valve.

17. The method of claim 12 wherein the cycling includes cycling a solenoid assembly, which is communicable with a first fluid passage and a second fluid passage, between an energized condition wherein pressure detected at a pressure sensor is a pressure of the first fluid passage and a de-energized condition wherein pressure detected at the pressure sensor is a pressure of the second fluid passage, one of the first and second fluid passages being an upstream pressure with respect to the other.

18. The method of claim 17 wherein the cycling causes the pressure sensor to output a pressure difference of the pressures of the first fluid passage and of the second fluid passage detected by the pressure sensor.

19. The method of claim 17 wherein the first fluid passage connects to the solenoid assembly at a first port of the solenoid assembly, the second fluid passage connects to the solenoid assembly at a second port of the solenoid assembly, and the solenoid assembly is a double-acting solenoid assembly.

20. The method of claim 17 wherein the first fluid passage connects to the solenoid assembly at a first port of the solenoid assembly, a connector passage connects the solenoid assembly to the pressure sensor, the second fluid passage connects to the connector passage between the solenoid assembly and the pressure sensor, an orifice is positioned between the connector passage and the second fluid passage, and the solenoid assembly is a single-acting solenoid assembly.
